(19) United States
(12) Patent Application Publication
(10) Pub. No.: US 2025/0324486 A1
(43) Pub. Date: Oct. 16, 2025

(54) MULTIFUNCTIONAL EXTRACTOR HOOD

(71) Applicant: FABER S.p.A., Fabriano (AN) (IT)

(72) Inventors: Alberto GASPARINI, Fabriano (AN) (IT); Emanno VANTAGGI, Fossato di Vico (PG) (IT)

(73) Assignee: FABER S.p.A., Fabrianzo (AN) (IT)

(21) Appl. No.: 19/174,216

(22) Filed: Apr. 9, 2025

(30) Foreign Application Priority Data
Apr. 16, 2024 (EP) 24170534.2

(51) Int. Cl. H05B 3/00; F24C 15/20

(52) U.S. Cl. CPC H05B 3/0076; F24C 15/20

(57) ABSTRACT

An extractor hood (1) with a housing (2), which housing (2) has an air inlet (4) for drawing in kitchen vapours and an air outlet (5) for evacuating or recirculating the kitchen vapours and in which housing (2) a suction fan (3) is arranged between the air inlet (4) and the air outlet (5). At least one radiant heating element (7) is arranged in the region of the air inlet (4). The extractor hood (1) further includes a cover element (8) for the radiant heating element (7), which cover element (8) is movable between a first position, in which it covers the radiant heating element (7), and a second position, in which it is arranged at a free distance (FD) from the radiant heating element (7).

### CROSS-REFERENCE TO RELATED APPLICATIONS

This application claims priority from European Patent Application No. EP 24170534.2, filed Apr. 16, 2024, which is incorporated in its entirety herein as if fully set forth.

### TECHNICAL FIELD

The invention relates to an extractor hood with a housing, which housing has an air inlet for drawing in kitchen vapours and an air outlet for evacuating or recirculating the kitchen vapours. In said housing a suction fan is arranged between the air inlet and the air outlet, and at least one radiant heating element is arranged in the region of the air inlet.

### BACKGROUND

Such an extractor hood is known from DE 77 36 750 U1. Said document discloses an electric extractor hood, in particular for use with so-called party grills, with an air filter and a fan conveying the air through the latter. This extractor hood is designed as a movable table-top appliance. According to an advantageous embodiment, the previously known extractor hood has a downward-radiating infrared radiation source, such as an infrared lamp or a tubular heating element, so that it can be used to keep food warm or, if the corresponding power is available, to cook or bake food on the table.

Using an infrared for cooking food by radiation (from above) provides several advantages, e.g., improved heating efficiency, healthier and fat-free cooking, and the elimination of charring effects of contact cooking.

However, the previously known table-top device can only be used to a limited extent. It has also been found that the infrared radiation source is easily soiled during operation and is difficult to clean.

There is a need for an improved extractor hood of the above-defined type that is more versatile in use and less likely to become soiled, especially if the extractor hood is to be installed in a kitchen and is also used in combination with regular cooking hobs, e.g., gas hobs or induction hobs, that are installed in a kitchen worktop.

### SUMMARY

It is the object of the present invention to provide such an improved versatile multifunctional extractor hood.

The object is achieved by means of an extractor hood having one or more of the features disclosed herein.

Advantageous further embodiments of the extractor hood in accordance with the invention are defined in below and in the claims.

An extractor hood according to the present invention has a housing, which housing has an air inlet for drawing in kitchen vapours and an air outlet for evacuating the kitchen vapours or for recirculating the kitchen vapours (preferably after appropriate filtration thereof, as known). In said housing a suction fan is arranged between the air inlet and the air outlet. Furthermore, at least one radiant heating element is arranged in the region of the air inlet. The extractor hood according to the present invention is characterised by a cover element for the radiant heating element, which cover element is movable between a first position, in which it covers the radiant heating element, and a second position, in which it is arranged at a free distance from the radiant heating element.

In this way, the radiant heating element is protected by the cover element when it is not in use, so that it is less susceptible to soiling, which is most important if the extractor hood is (to be) installed above a regular worktop cooking hob. With the cover element in its second position, the radiant heating element can be used to cook food or keep it warm, which food can be placed in/on the cover element. The extractor hood is therefore particularly versatile in use and serves to evacuate kitchen fumes in the usual way while further enabling (healthy) infrared cooking and/or allowing cooked food to be kept warm.

Any known radiant heating element can be used as the radiant heating element. Electrically operated radiant heating elements are preferred, e.g., infrared lamps or heating resistors. Preferred power is between 500 and 3000 W and is most preferably adjustable by the user.

In a further embodiment of the extractor hood according to the invention the radiant heating element is configured as an infrared radiation element.

Such a design has proved particularly useful and efficient.

In a further embodiment of the extractor hood according to the invention the radiant heating element is arranged behind a glass ceramic panel.

In this way, soiling of the heating element itself can be prevented. The glass ceramic panel is known to be heat resistant and can be cleaned easily. It also has a spatially homogenising effect on the emitted heat radiation.

In a further embodiment of the extractor hood according to the invention it comprises a motor means, preferably an electric motor means, for moving the cover element up and down, in particular between said first and second positions.

This enables convenient and comfortable operation of the extractor hood. However, the invention is not limited in this respect: the up and down motion of the cover element can be achieved through an electric motor (as described above), but can also be achieved manually, wherein the cover element is moved and adjusted in height manually by the user using, e.g., a mechanism of linear guides and a worm gear.

In a further embodiment of the extractor hood according to the invention the air inlet extends circumferentially, preferably fully circumferentially, around the radiant heating element.

This is particularly space-saving and allows a large cross-section for the inlet opening.

In a further embodiment of the extractor hood according to the invention the air inlet extends circumferentially, preferably fully circumferentially, around the cover element when the latter is located in the first position.

In this way, the extractor hood remains fully operational when the cover element is in its first position, i.e., when the radiant heating element is not in use.

In a further embodiment of the extractor hood according to the invention the cover element is designed as a flat cuboidal hollow body which is open on its upper side facing the radiant heating element.

In this way, the radiant heating element is well protected when the cover element is in its first position.

In a further embodiment of the extractor hood according to the invention the cover element, in particular in the second position, is designed to hold dishes or food to be prepared, if necessary, together with corresponding cookware.

In other words: the cover element, due to its cuboidal hollow shape, can serve as a kind of tray for holding dishes or food.

In a further embodiment of the extractor hood according to the invention an additional cooking means is inserted or insertable into the cover element, in particular a cast iron plate, a soapstone, a pizza baking stone, a lava stone or a plancha.

In this way, the food can also be cooked from below, which can even further improve the cooking and flavour experience.

In a further embodiment of the extractor hood according to the invention the additional cooking means is itself actively heated or heatable (e.g., by means of electric power).

This further enhances the above-described advantages. Preferably, the cover element comprises dedicated further means, e.g., a plug connector, for to provide (electrical) energy to said additional cooking means.

In a further embodiment of the extractor hood according to the invention the cover element comprises a removable and preferably washable insert.

In this way, the cover element can be easily cleaned after use, e.g., in a kitchen sink or a dishwasher, by simply removing and cleaning said insert, which can take the form of a tray.

In a further embodiment of the extractor hood according to the invention the insert is laterally extractable from the cover element, in particular together with the additional cooking means.

To this end, the cover element can have a lateral cut-out or opening. In this way, handling of the insert for removal, cleaning and reinsertion is particularly easy.

In yet a further embodiment of the extractor hood according to the invention the cover element is approximately 200 to 250 mm away from the radiant heating element in the second position. Alternatively, the cover element can be approximately 150 to 180 mm away from the radiant heating element in the second position.

Applicant has found that such distances may produce very good cooking results. However, the invention is not limited by these values. Furthermore, the best distance will depend on the power of the radiant heating element and/or on the type/amount of food to be cooked or kept warm (reheated, defrosted, . . . ).

In still a further embodiment of the extractor hood according to the invention a distance of the cover element in the second position from the radiant heating element is freely adjustable.

In this way, the device can be “fine-tuned” by the user to best achieve an intended result, in particular by additionally adjusting a power of the radiant heating element.

In a preferred further embodiment of the extractor hood according to the invention it comprises a control device configured such that the radiant heating element can only be activated when the cover element is in the second position. The same holds, preferably, for said the additional cooking means.

In this way, any unintentional activation and damage of the extractor hood can be prevented.

The control device can be further configured such that the radiant heating element can only be activated when the fan of the extractor hood is running. The same holds, preferably, for said the additional cooking means.

In this way, any cooking vapours produced by the radiant heating element will be automatically eliminated.

### BRIEF DESCRIPTION OF THE DRAWINGS

Further advantages and characteristics of the invention will become apparent from the following description of preferred embodiments with reference to the drawings.

FIG. 1 shows a longitudinal sectional view of an extractor hood according to the invention with the cover element in the first position;

FIG. 2 shows a perspective view of the extractor hood of FIG. 1;

FIG. 3 shows a perspective view as in FIG. 2 with the cover element in the second position;

FIG. 4 shows a different perspective view of the extractor hood of FIG. 3;

FIG. 5 shows a longitudinal sectional view of an extractor hood according to the invention with the cover element in the second position;

FIG. 6 shows a perspective view of an extractor hood according to the invention with a removeable insert; and

FIG. 7 shows a perspective view of an extractor hood according to the invention with an additional cooking means.

### DETAILED DESCRIPTION

In all of the drawings, the same reference numerals are used to indicate identical features or features that have at least an identical function.

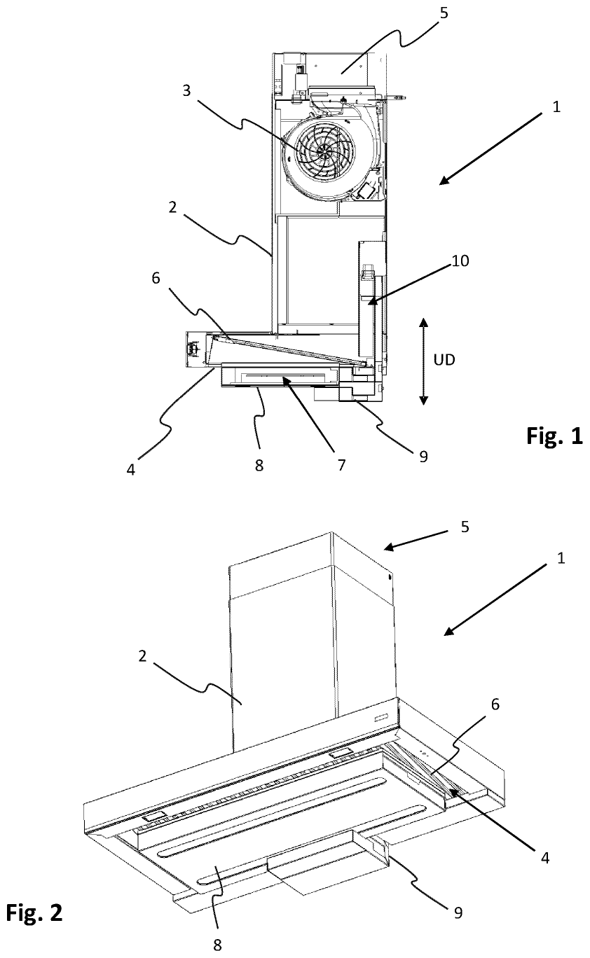

FIG. 1 shows an extractor hood 1 according to the invention in a longitudinal section. The extractor hood has a housing 2 that encloses, inter alia, a centrifugal fan 3. Said fan is used to draw in air (kitchen vapours) and to evacuate (or recirculate) them. To this end the extractor hood 1, i.e., the housing 2 has an air inlet 4 and an air outlet 5. The fan 3 is located in an air flow path between air inlet 4 and air outlet 5. Reference numeral 6 denotes a grease filter that is located in said air flow path in front of the fan 3 (in a direction of air flow). Especially if the extractor hood 1 is devised for recirculation, further filter means (HEPA, charcoal, etc.) can be present (not shown).

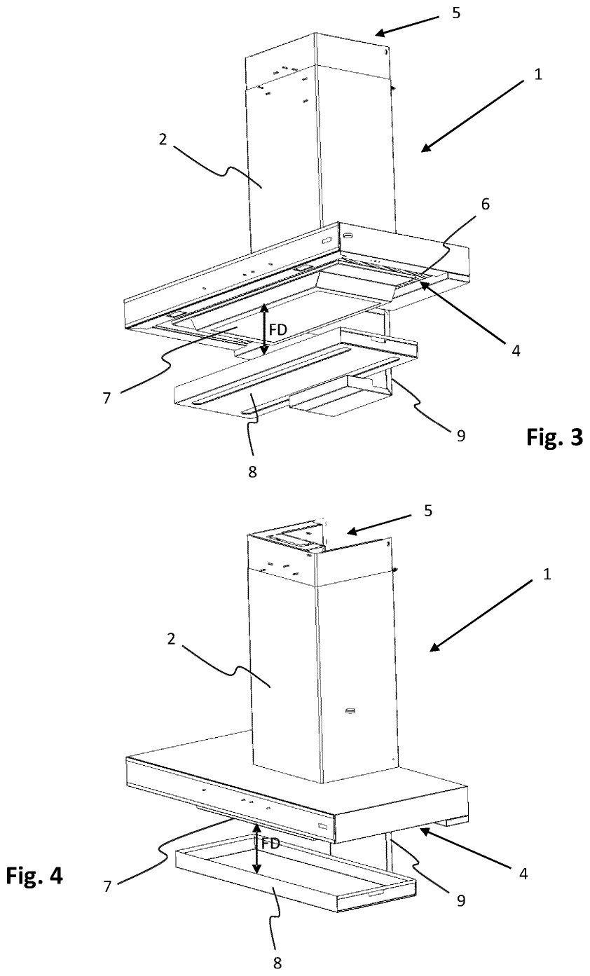

The extractor hood 1 according to the invention further has an infrared radiant heating element (hereinafter also referred to as “heating element”) 7 that is located below the housing 2 in a region of the air inlet 4. The actual heating element 7 is preferably located behind a glass ceramic panel or the like, which is not denoted separately. In the embodiment of FIG. 1, said heating element 7 is covered by a tray like cover element 8, preferably made of metal (e.g., stainless steel) of flat cuboidal shape that is located in a first dedicated position in which it covers the heating element 7. More specifically, the cover element 8 is designed as a flat cuboidal hollow body which is open on its upper side facing the radiant heating element 7. Said cover element 8 is held by one end of an L-shaped support arm 9, the other end of which is located inside housing 2 in operative connection with a motor means 10 for moving support arm 9 and cover element 8 up and down (according to arrow UD) between said first position and a dedicated second position (cf. FIG. 3 ff).

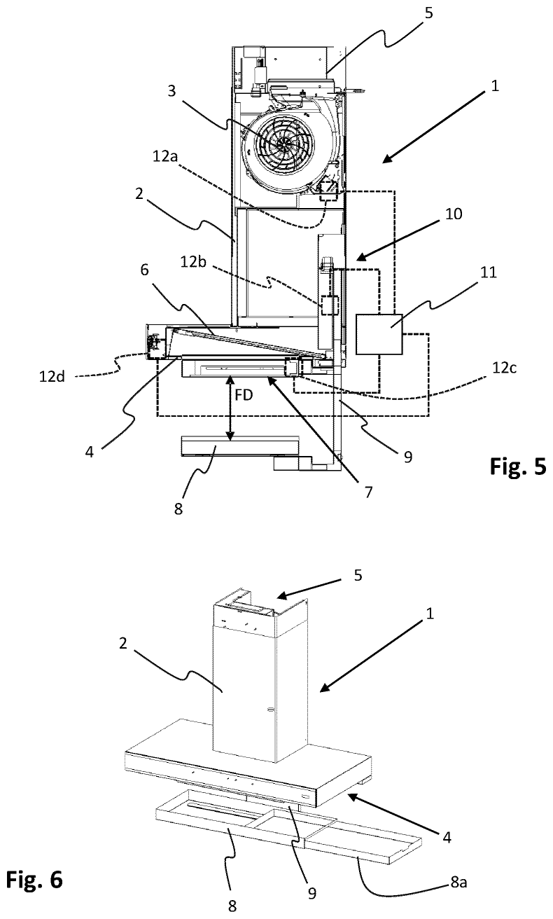

Operation of the extractor hood 1, i.e., of fan 3, heating element 7 and motor means 10, is controlled by means of a control unit (not shown in FIG. 1), as will be explained further down with reference to FIG. 5.

FIG. 2 shows the extractor hood of FIG. 1 in a perspective view from below. As can be gathered from said Figure, the air inlet 4 extends circumferentially all around said cover element 8 in the first position thereof (and also all around the heating element 7). With the cover element 8 in its first position, the heating element 7 is protected against contamination, e.g., from cooking vapours from a cooking hob (not shown).

FIG. 3 shows the extractor hood 1 of FIGS. 1 and 2 with the cover element 8 in its second position. Thus, the heating element 7 is now exposed and can be used to cook, reheat or defrost foodstuff that is placed on (in) cover element 8. To enable this, the cover element 8 is designed to hold dishes or food to be prepared, if necessary together with corresponding cookware (thus the hollow cuboid shape).

In said second position of the cover element 8, a free distance FD between the cover element 8 and the heating element 7 preferably is between 200 and 250 mm. However, the invention is not limited to this specific distance value. Other values may be advantageous under particular circumstances, depending on the type of food to be prepared, on a power of the heating element 7, and so forth. Said free distance FD can either be measured between an underside of the heating element 7 and a bottom of the cover element 8 or between an underside of the heating element 7 and an upper edge of the cover element 8.

FIG. 4 shows the extractor hood 1 of FIG. 3 from a different perspective. As can be gathered from FIG. 4, the cover element 8 has a tray-like hollow shape which allows to place foodstuff therein.

FIG. 5 shows the extractor hood 1 of FIG. 4 in a sectional view similar to FIG. 1. In addition to FIG. 1, FIG. 5 schematically depicts a control unit 11 and a number of sensors/actuators 12a-d in operative connection with said control unit 11. As will be appreciated by the skilled person, control unit 11 will—in practice—be contained with the housing 2 of the extractor hood 1.

Reference numeral 12a denotes a sensor/actuator in connection with fan 3; reference numeral 12b denotes a sensor/actuator in connection with said motor means 10 for moving the support arm 9; reference numeral 12c denotes a sensor/actuator in connection with heating element 7; and reference numeral 12d denotes a sensor/actuator in the form of a user interface for controlling an operation the extractor hood 1 by means of user input.

Signals to/from said sensors/actuators 12a-d are sent to/from control unit 11 which is in charge of controlling operation of the extractor hood 1 and is devised accordingly.

In this way, the following features (without limitation) can be easily implemented by the control unit 11:

Heating element 7 can only be turned on when cover element 8 is in its second position or at least lowered with respect to the situation in FIG. 1. For instance, if the user turns on heating element 7 via user interface 12d, control unit 11 will first activate motor means 10 (via actuator 12b) to lower the cover element 8 (if the latter had not been lowered before) prior to activating the heating element 7 through actuator 12c.

Further, control unit 11 may measure a temperature of heating element 7 via sensor 12c prior to raising the cover element 8. Cover element 8 may only be raised if said temperature has dropped below a certain threshold.

Also, the heating element 7 can only be turned on if the fan 3 has been activated. Thus, control unit 11 may automatically switch on fan 3 via actuator 12a if the user selects activation of the heating element 7 via user interface 12d.

Preferably, when the user selects activating the heating element 7 via user interface 12d, control unit 11 will automatically lower the cover element 8 and turn on fan 3 before powering the heating element 7. In another embodiment, activation of heating element 7 may be blocked until user has lowered the cover element 8 and turned on the fan 3.

Raising the cover element 8 may be blocked until sensor/actuator 12c signals that a temperature of the heating element 7 has dropped below a predefined threshold.

The user may also control a power of the heating element 7, e.g., between 500 and 3000 W, via user interface 12d and control unit 11. In the same way, said free distance FD (cf. FIGS. 3 and 4) may be controlled via user interface 12d, control unit 11, actuator/sensor 12b and motor means 10. Control unit 11 may store predefined programmes that link a power of the heating element 7 to a value for said free distance FD. There can also be a link to a given (adjustable) suction power of fan 3.

FIG. 6 is similar to FIG. 4. It shows a particularly useful embodiment of cover element 8 that may comprise a (laterally) removeable or extractable insert 8a. The insert is of tray to trough-like shape and preferably washable (e.g., in a dishwasher) which enables easy cleaning of the cover element 8, i.e., the part thereof that comes in contact with the food. To this end, the cover element 8 has a lateral cut-out or opening. In this way, handling of the insert 8a for removal, cleaning and reinsertion is particularly easy.

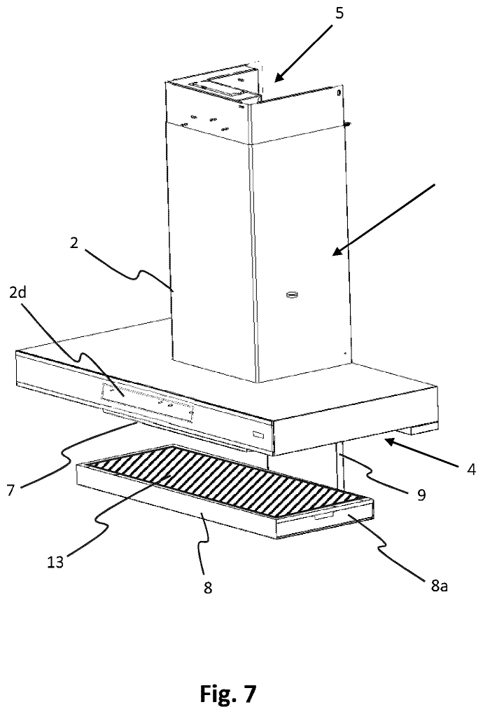

According to FIG. 7, the cover element 8 can hold an additional cooking means 13. The additional cooking means 13 is inserted or insertable into the cover element 8 and preferably fills up the hollow interior thereof. In particular, the additional cooking means 13 can take the form of a cast iron plate, a soapstone, a pizza baking stone, a lava stone or a plancha (without limitation). It permits to cook the food from above and from below for an even more sophisticated cooking experience.

The additional cooking means 13 is itself preferably actively heated or heatable and can be controlled via user interface 12d. To this end, cover element 8 can have an internal (electric) power connection (not shown) that passes through support arm 9 for connecting and powering the additional cooking means 13. More preferably, the additional cooking means 13 can be removed (disconnected) from the cover element 8 together with or separate from the insert 8a.

In a preferred embodiment, the additional cooking means 13 is removed from the cover element 8 together with insert 8a and at the same time also (electrically) disconnected from the cover element 8, if appropriate. Then, the additional cooking means 13 can be separated from the insert 8a prior to cleaning. For reassembly, the additional cooking means 13 is first placed into the insert 8a, and then both said elements are reinserted into the cover element 8 whereby the additional cooking means 13 is automatically (electrically) reconnected, if appropriate.

Motor means 10 is preferably powerful enough to lift and lower the cover element 8 together with the additional cooking means 13.

In the case of a soapstone or pizza baking stone, the additional cooking means 13 may be preheated in a regular oven and then placed in the cover element 8 in its preheated state. It may also be heated when already inside the cover element 8 by activating the heating element 7 for some time prior to placing the food (preferably, the cover element 8 is located close to the heating element 7 during this process, which may be a predefined programme of the control unit 11, cf. FIG. 5).

In the above, the invention has been described in exemplary fashion in connection with a motor means 10 for moving the cover element 8. However, as already stated, the invention is not limited in this respect: the up and down motion of the cover element 8 can either be achieved through an electric motor (motor means 10, as described above), or it can be achieved manually, wherein the cover element 8 is moved and adjusted in height manually by the user using, e.g., a mechanism of linear guides and a worm gear, while keeping unchanged the above-described principles of activation and management of the heating element 7 and the various distances of the cover element 8 therefrom for different uses (cooking, heating, etc.).

1. An extractor hood (1), comprising:
a housing (2) having an air inlet (4) for drawing in kitchen vapours and an air outlet (5) for evacuating or recirculating the kitchen vapours;
a suction fan (3) arranged in the housing (2) between the air inlet (4) and the air outlet (5);
at least one radiant heating element (7) arranged in a region of the air inlet (4);
a cover element (8) for the radiant heating element (7), the cover element (8) being movable between a first position, in which the cover element (8) covers the radiant heating element (7), and a second position, in which the cover element (8) is arranged at a free distance (FD) from the radiant heating element (7).

2. The extractor hood (1) according to claim 1, wherein
the radiant heating element (7) comprises an infrared radiation element.

3. The extractor hood (1) according to claim 1, further comprising a glass ceramic panel, and the radiant heating element (7) is arranged behind the glass ceramic panel.

4. The extractor hood (1) according to claim 1, further comprising
a motor (10) arranged to move the cover element (8).

5. The extractor hood (1) according to claim 1, wherein
the air inlet (4) extends circumferentially around the radiant heating element (7).

6. The extractor hood (1) according to claim 1, wherein
the air inlet (4) extends circumferentially around the cover element (8) when the cover element (1) is located in the first position.

7. The extractor hood (1) according to claim 1, wherein
the cover element (8) comprises a flat cuboidal hollow body which is open on an upper side thereof facing the radiant heating element (7).

8. The extractor hood (1) according to claim 7, wherein
the cover element (8) is adapted to hold dishes or food to be prepared.

9. The extractor hood (1) according to claim 7, further comprising
an additional cooking element (13) inserted or insertable into the cover element (8).

10. The extractor hood (1) according to claim 9, wherein the additional cooking element (13) comprises a cast iron plate, a soapstone, a pizza baking stone, a lava stone or a plancha.

11. The extractor hood (1) according to claim 9, wherein
the additional cooking element (13) is actively heated or heatable.

12. The extractor hood (1) according to claim 7, wherein
the cover element (8) comprises a removable insert (8a).

13. The extractor hood (1) according to claim 12, wherein
the insert (8a) is laterally extractable from the cover element (8).

14. The extractor hood (1) according to claim 1, wherein
the cover element (8) is approximately 200 to 250 mm away from the at least one radiant heating element (7) in the second position.

15. The extractor hood (1) according to claim 1, wherein
the cover element (8) is approximately 150 to 180 mm away from the radiant heating element (7) in the second position.

16. The extractor hood (1) according to claim 1, wherein
a distance of the cover element (8) in the second position from the radiant heating element (7) is freely adjustable.

17. The extractor hood (1) according to claim 1, further comprising
a control device configured such that the radiant heating element (7) is adapted to only be activated when at least one of a) the cover element (8) is in the second position, or b) the fan (3) is activated.
